(19) United States
(12) Patent Application Publication
(10) Pub. No.: US 2011/0115207 A1
(43) Pub. Date: May 19, 2011

(54) HEAVY WEIGHT PAPER PAD WITH REMOVABLE AND TEARABLE SHEETS

(76) Inventor: Jon Richard MARTENSSON, South Hadley, MA (US)

(21) Appl. No.: 12/617,801

(22) Filed: Nov. 13, 2009

(51) Int. Cl. B42D 1/00

(52) U.S. Cl. 281/21.1; 281/29

(57) ABSTRACT

A pad of heavy weight paper which can be inserted and removed from a wire binding. Each sheet contains a patterned edge having openings with an entrance for receiving a strand of the wire binding. Arrow shaped projections are formed between the openings. A line of perforations in each sheet allows the edge with the pattern to be torn off. The sheets maybe removed and reinserted. Also, the edges may be removed if the sheet is to be displayed.

### BACKGROUND OF THE INVENTION

1. Field of the Invention

The present invention relates generally to a pad of heavy weight paper and more particularly to a pad of heavy weight paper where the sheets may be removed and reinserted and are perforated to permit tearing.

2. Discussion of the Background

Traditionally, artist's pads have been made of heavy weight paper such as Bristol Board, which may be 0.015 inch in thickness. This heavy paper is necessary to support the various media that are used by the artists such as paint, watercolor, pastels, pencil and other media without being saturated and to retain its shape so as to avoid damaging the artwork. These pads are usually held together by an adhesive binding at the edge of the sheets. Unfortunately, this type of binding tends to weaken as the pad is opened and closed repeatedly, so that the pages eventually become detached and may fall out. Also, the adhesive may leave a residue on the edge of the sheet.

A number of other types of bindings have also been designed, especially for lighter weight paper. British patent specification 485,477 filed Nov. 25, 1936 shows an arrangement with a wire binding having prongs made of two parallel strands. The paper has T-shaped slots along one edge for receiving the binding prongs. The projecting portions between the slots are in the shape of an arrow head. The paper is removed by a tearing-out action which does not damage the slots. The paper may be reinserted into the binding.

U.S. Pat. No. 6,431,780 shows a notebook with removable paper sheets. The sheets have two sets of holes for a three ring binder and also holes for a spiral binding. A set of perforations is provided in a line spaced from one edge. The paper may be torn along the perforations to reduce the width of the paper and the sheet placed in a three ring binder using the inner set of holes.

U.S. Pat. No. 4,430,015 shows a wire bound notebook with a fastening device for attaching items to the binding. The fastening device includes a strip with notches leading to apertures, where the notches allow the wire of the binding to be inserted into the apertures.

These and other arrangements do not provide satisfactory bindings for such heavy weight paper. Weak bindings cannot withstand the forces necessary to remove a heavy sheet. Further, the heavy paper is difficult to tear, and if torn from the binding leaves paper scraps on the wire binding which are unsightly. It is desirable to create a binding arrangement which can withstand the forces necessary for tearing out a heavy weight paper, and which permits removal and reinsertion of the sheets.

### SUMMARY OF THE INVENTION

The present invention provides a pad of paper with a wire binding in which sheets can be removed and reinserted.

The present invention provides a pad of heavy weight paper where the sheets can be inserted and removed and the paper is perforated for tearing.

The present invention provides a pad of artist's paper having a microperforation line for tearing and arrow shaped tabs along one edge for insertion of the edge into the binding.

The present invention still further provides a pad of heavy weight paper in book form, with each sheet having a microperforation line for tearing the sheet to remove the edge which is inserted into the binding.

The present invention still further provides a book of Bristol Board paper having sheets with a punched pattern which interacts with a wire binding to allow sheets to be inserted and removed.

This is accomplished by providing sheets of heavy weight paper between a front and back cover which are bound by a wire binding, each sheet having an arrow shaped pattern along one edge which interacts with the binding to allow the sheet to be inserted and removed. Each sheet is also perforated in a line to allow the sheet to be torn to leave a clean edge and remove the patterned edge.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a front view of a sheet of paper according to the present invention; and

FIG. 2 is a front view of a pad of paper according to the present invention.

### DETAILED DESCRIPTION OF THE PREFERRED EMBODIMENTS

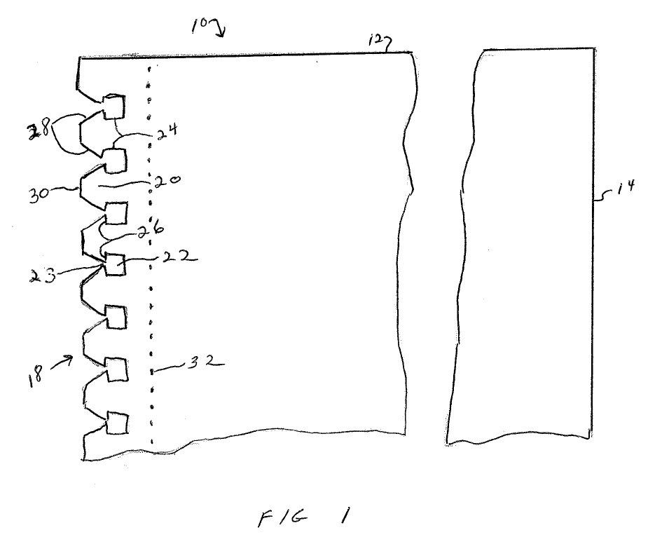

Referring now to the drawings, wherein like reference numerals designate identical or corresponding parts throughout the several views, and more particularly to FIG. 1 thereof, wherein a sheet 10 of heavy weight paper used by artists, such as Bristol Board paper is shown.

The sheet has a traditional straight top edge 12 and a traditional straight right edge 14. The particular size of the sheet may vary as desired. A bottom edge 16 (not shown) would also be a straight traditional edge. While these edges are traditionally straight and perpendicular, other arrangements are likewise possible. The left edge 18 has a specific pattern cut or punched into the sheet for interaction with the binding.

The pattern includes a series of square shaped openings 22 into which a wire binding will fit. While the opening is shown as a square, other shapes are also possible. The side of the square nearest the edge has an entrance channel 23, which allows the wire binding to enter the square opening 22.

The area between the openings forms arrow shaped projections 20. The shaft of the arrow is formed from the sides 24 of the square opening. Horizontal edges 26 extend to form the entrance channel and the bottom of the arrow head. Sloped edges 28 form the two sides of the arrow head and horizontal edge 30 forms the end of the arrow head.

The sheet also has a line of perforations 32 to enable the user to tear the main part of the sheet from the left edge of the sheet containing the binding pattern. Preferably, the perforations are microperforations so as to be nearly invisible on the sheet. The size and spacing of each perforation may be adjusted so that the sheet will not tear too easily, but still tear neatly when desired.

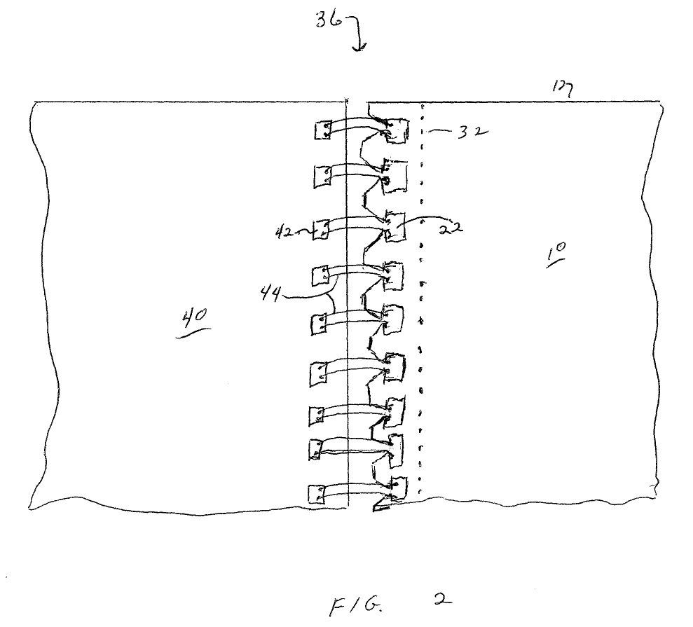

FIG. 2 shows the sheet 10, on the right, as the top sheet in a pad or book 36, with a cover 40, on the left. A similar cover (not shown) may be provided under the last sheet in a traditional manner. The covers have openings 42 which are square shaped, but may be any desired shape that is suitable to receive the binding. The openings 42 correspond to openings 22 in the sheets 10. The binding is made of wires 44, in a known arrangement of two parallel strands for each opening. Each pair of strands extends between an opening 42 and an opening 22 to hold the sheets in the pad. The wires are bent to connect adjacent pairs behind the back cover in a known manner. In the openings 22 of the sheets 10, each wire extends behind a horizontal edge 26 to hold the arrow shaped projection 20 in position.

In manufacturing the pad, the sheets are cut to size and the edge punched or cut as described. Perforations are also provided in the sheets. Likewise, the covers are cut to size and the openings punched in a known manner. The sheets and cover are assembled and the wire binding is inserted in position by bending a long strand of wire so as to form the dual loop arrangement described above. It would also be possible to connect the covers with a binding first and then insert the sheets, but the preferable manner is to form the pad as a whole.

Once the pad is assembled, the artist may paint or draw on the individual sheets while in the pad, if desired, or an individual sheet may be removed so that it may be placed on an easel or other convenient surface. This is especially advantageous for media which requires drying time. When the project is finished and dry, the sheet may be reinserted into the pad without damage to the sheet or binding. Thus, the pad can continue to hold finished work as a protective archival system and the binding will not weaken and drop the sheets no matter how many times the sheets are removed. If it is desired to display a work, the sheet may be removed and the left edge torn off at the perforations to remove the binding pattern and leave a sheet with straight edges.

It is also possible to use only a single cover rather than a front and back cover. The shape of the openings in the sheets, especially the flat side toward the sheet itself, allows the pad to be retained in a manner not possible with the prior art.

The present invention provides a preferable arrangement to prior art devices. The patterned edge allows the heavy weight paper to be easily removed without damaging either the paper or the binding. The paper slips from the binding without pulling or deforming the binding using a pulling motion from the top down. The sheet may be removed from the binding before tearing the edge from the binding if desired to avoid any unnecessary pulling on the binding. This also avoids any part of the edge piece from being left on the binding. Removing this paper remnant after tearing can also damage the wire. It also allows the user to bend the perforation back or bend it over a hard edge for easier tearing. Further, removing the sheet before folding and tearing makes the process easier and avoids wrinkles and folds in the paper. Prior art devices mostly have been used with lighter weight paper which tears more easily so that deforming the binding is not a problem. The present invention provides an arrangement for heavy weight paper which was not available before.

Numerous additional modifications and variations of the present invention are possible in light of the above teachings. It is therefore to be understood that within the scope of the appended claims, the invention may be practiced otherwise than as specifically described herein.

1. A sheet of heavyweight paper, comprising:
a front face and a back face;
four edges, three of which are straight edges and one of which is a patterned edge; and
a perforation line parallel to and spaced from said patterned edge for separating said patterned edge from a main part of said sheet;
said patterned edge including:
openings for receiving a binding, each opening having an entrance channel for allowing the binding to enter the opening; and
projections between said openings for insertion into the binding, the projections being arrow shaped.

2. The sheet according to claim 1, wherein a shaft of the arrow shaped projection is formed by the sides of said openings, a base of a head of the arrow shape forming the entrance channel.

3. The sheet according to claim 1, wherein the heavyweight paper is artist paper.

4. The sheet according to claim 1, wherein the heavyweight paper is Bristol Board.

5. The sheet according to claim 1, wherein the heavyweight paper has a thickness of 0.015 inch.

6. The sheet according to claim 1, wherein the perforation line allows the sheet to be torn to form a display quality sheet.

7. The sheet according to claim 1, wherein the patterned edge allows removal and insertion of the sheet into the binding.

8. A pad of heavyweight paper sheets, comprising:
a front cover;
a back cover;
a binding;
a plurality of sheets of heavyweight paper, each sheet including:
a front face and a back face;
four edges, three of which are straight edges and one of which is a patterned edge; and
a perforation line parallel to and spaced from said patterned edge for separating said patterned edge from a main part of said sheet; said patterned edge including openings for receiving a binding, each opening having an entrance channel for allowing the binding to enter the opening; and projections between said openings for insertion into the binding, the projections being arrow shaped.

9. The pad according to claim 8, wherein the binding is a wire binding with a dual loop arrangement.

10. The pad according to claim 8, wherein a shaft of the arrow shaped projection is formed by the sides of said openings, a base of a head of the arrow shape forming the entrance channel.

11. The pad according to claim 8, wherein the heavyweight paper is artist paper.

12. The pad according to claim 8, wherein the heavyweight paper is Bristol Board.

13. The pad according to claim 8, wherein the heavyweight paper has a thickness of 0.015 inch.

14. The pad according to claim 8, wherein the perforation line allows the sheet to be torn to form a display quality sheet.

15. The pad according to claim 8, wherein the patterned edge allows removal and insertion of the sheet into the binding.
